(19) United States
(12) Patent Application Publication
(10) Pub. No.: US 2019/0069712 A1
(43) Pub. Date: Mar. 7, 2019

(54) POWDERED SUPPLEMENT DISPENSING STATION

(71) Applicants: Fabio Comana, La Mesa, CA (US); Todd C. Schneider, Medicine Hat (CA)

(72) Inventors: Fabio Comana, La Mesa, CA (US); Todd C. Schneider, Medicine Hat (CA)

(21) Appl. No.: 16/045,247

(22) Filed: Jul. 25, 2018

Related U.S. Application Data
(60) Provisional application No. 62/554,917, filed on Sep. 6, 2017.

(51) Int. Cl. A47J 31/40; A23L 2/39

(52) U.S. Cl. CPC A47J 31/404; A47J 31/4403; A23L 2/39

(57) ABSTRACT

A dispensing station houses several container stations in which various powdered materials can be placed for dispensing. The container stations can each include a canister mount that accepts a standard sized canister of powdered material, and can be disposed on a rotating structure that can be rotated by a user to select one of the container stations for dispensing a powdered material held in the selected container station. The rotating structure can further include dispensing trucks located underneath the container stations. The dispensing trucks can dispense a measured quantity of the powdered material when a dispending truck for the selected container station is activated. Activation of dispensing trucks can be controlled and enabled subject to receiving a payment.

### CROSS-REFERENCE TO RELATED APPLICATION

This application is a non-provisional application based on, and claiming priority to U.S. Provisional Patent Application No. 62/554,917 filed on Sep. 6, 2017, the entirety of which is incorporated by reference.

### FIELD OF THE INVENTION

The present invention relates generally to dispensing system, and, more particularly, relates to a dispensing system for dispensing a variety of powdered or granulated material from canisters.

### BACKGROUND OF THE INVENTION

Nutritional and dietary supplements account for a significant worldwide market that is predicted by some commentators to approach $300 billion within the next ten years. Supplements are sold in both powder and tablet/capsule form, but increasing they are being offered in the food service industry. For example, smoothie shops are now common, and they typically offer a wide variety of supplement add-ins that customers can choose to have added to a smoothie. Of the many different types of supplements, some have been developed that are optimally consumed at specific times, relative to exercise activity. That is, there are supplements that are optimally consumed before exercise/training, and some that are optimally consumed after exercise/training. It is common for people to conduct their exercise or training regimen away from their home, such as at a gym or other such facility, and it is often not convenient or possible to travel back home after an exercise or training session. As a result, it is common for people to carry supplements with them to the place where they conduct their exercise or training, and then prepare and consume the supplement there.

One problem that arises from carrying supplement material to a place like a gym or other facility is that the supplement material is typically sold in powered form, and packaged in powdered or granular form in bulk packaging, which is not desirable for a person to carry for use after an exercise or training session. In addition to the extra weight, the person must measure out the right amount of supplement, which can lead to spills. In some cases, a container may come open in when being carried inside a bag (e.g. gym bag) or other carry item, spilling supplement powder inside the bag. Sometimes a person may forget to bring their supplement(s) with them.

Another problem that arises with the increase in supplement popularity is that of waste and the impact on the environment. The packaging for supplements includes foil coated films and other plastic containers. As these become more popular, the waste problem increases in kind.

Therefore, a need exists to overcome the problems with the prior art as discussed above.

### SUMMARY OF THE INVENTION

The invention provides a powdered supplement dispensing station that overcomes the hereinafore-mentioned disadvantages of the heretofore-known devices and methods of this general type and that allows a user to select one of a variety of sizes, or different supplements, to be dispensed.

Some embodiments of the invention can include a dispensing station for dispensing powder and granulated material into beverage containers can include a rotating structure having a canister level and a dispenser level which rotate together about a central axis. The canister level including a plurality of canister mounts that are each configured to receive a canister and direct material contained in the canister through a port in a bottom of the canister mount. The dispenser level include a plurality of dispensing trucks, where each one of the plurality of dispensing trucks positioned underneath a respective one of the plurality of canister mounts on the dispenser level, and is moveable between a filling position and a dispensing position. For each dispensing truck, in the filling position a cup portion of the dispensing truck is aligned with the respective port under the respective canister mount, and in the dispensing position a dispensing hole in a bottom of the cup portion is aligned with a receiving port of a dispensing chute. The dispensing chute is configured to direct a powdered or granular material from the cup portion to a container positioned under a dispensing end of the dispensing chute. The dispensing station can further include an actuator mounted in a fixed position with respect to the rotating structure that is configured to move a selected one of the dispensing trucks between the filling and dispensing positions. The selected one of the dispensing trucks is selected by rotating the rotating structure until the selected one of the dispensing trucks is in alignment with the actuator.

In a further embodiment there is provided, for each one of the plurality of dispensing trucks, a respective one of a corresponding plurality of biasing springs that biases the one of the plurality of dispensing trucks to the filling position.

In a further embodiment there is provided, each canister mount includes a protrusion positioned over the port that is configured to cut through a seal of a canister upon a canister being mounted on the canister mount.

In a further embodiment there is provided, the bottom of each canister mount is sloped from a sidewall of the canister mount to the port.

In a further embodiment there is provided, the actuator comprises a pushrod assembly that moves along a radius with respect to a center of the rotating structure.

In a further embodiment there is provided, wherein the actuator is inhibited from moving by a latch and latch control circuit that is responsive to a payment system, wherein upon the payment system receiving a payment, the latch control circuit releases the latch for one cycle of the actuator, thereby allowing dispensation of one portion.

In a further embodiment there is provided, at least two of the trucks have different sized cup portions.

Some embodiments of the invention can include a dispensing station for dispensing powder and granulated material into beverage containers that includes a plurality of container stations, each one of the container stations having either a container or a canister mount configured to receive a canister, and a dispensing truck of a plurality of dispensing trucks is disposed below the container station that is movable between a filling position and a dispensing position. In the filling position, each dispensing truck is positioned such at a cup portion of the dispensing truck is filled with material contained in the container or canister of the container station through a port, and when moved to the dispensing position a portion of the dispensing truck closes off the port. In the dispensing position, material in the cup portion exits the cup portion through dispensing hole in the cup portion into a dispensing chute, and when moved to the filling position the dispensing hole is closed off. The dispensing chute guides the material to a dispensing end of the dispensing chute. The dispensing trucks are moved by an actuator that is mounted in a fixed position, and wherein the plurality of container stations can be moved by a user to select a desired one of the container stations by aligning the selected one of the container stations with the actuator.

In a further embodiment there is provided, the container stations are disposed in a rotating structure which includes a canister level on which the container or canisters are located, and a dispenser level on which the plurality of dispensing trucks are disposed.

In a further embodiment there is provided, for each one of the plurality of dispensing trucks, a respective one of a corresponding plurality of biasing springs that biases the one of the plurality of dispensing trucks to the filling position.

In a further embodiment there is provided, for each container station which includes a canister mount, each canister mount includes a protrusion positioned over the port that is configured to cut through a seal of a canister upon a canister being mounted on the canister mount.

In a further embodiment there is provided, the bottom of each canister mount is sloped from a sidewall of the canister mount to the port.

In a further embodiment there is provided, the actuator comprises a pushrod assembly that moves along a radius with respect to a center of the rotating structure.

In a further embodiment there is provided, the actuator is inhibited from moving by an actuator control that is responsive to a payment system, wherein upon the payment system receiving a payment, the payment system releases the actuator control for one cycle of the actuator, thereby allowing dispensation of one portion.

In a further embodiment there is provided, at least two of the trucks have different sized cup portions.

In some embodiments, there is provided a method for dispensing powdered material that includes providing a dispensing station having a plurality of container stations. Each container station including a container of powdered material, and a dispensing truck located under the container that is moveable between a filling position and a dispensing position. The method further including moving the plurality of container stations relative to an actuator until a selected one of the container stations aligns with the actuator. The actuator is particularly aligned with the dispensing truck of the selected container station. The method further including moving the actuator, and thereby moving the dispensing truck of the selected container station from a filling position to a dispensing position, wherein a selected measure of the powered material is dispensed from the dispensing truck of the selected container station into a dispensing chute having a receiving port that corresponds with a dispensing hole in the dispensing truck when the dispensing truck is in the dispensing position.

In a further embodiment there is provided, moving the plurality of container stations comprises moving the plurality of container stations on a rotating structure.

In a further embodiment there is provided, at least two of the dispensing trucks have a different capacity, moving the plurality of container stations is based on the capacity of the dispensing trucks.

In a further embodiment there is provided, providing a payment to a payment system associated with the dispensing station, and responsive to receiving the payment, disabling a latch the is configured to prevent the actuator from moving a dispensing truck, thereby allowing the actuator to move.

In a further embodiment there is provided, each container station includes a canister mount, the method further comprises loading a canister of powered material into each of the canister mounts.

Although the invention is illustrated and described herein as embodied in a [TITLE], it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the component being described. Those skilled in the art can understand the specific meanings of the above-mentioned terms in the embodiments of the present invention according to the specific circumstances

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of a dispensing station for dispensing a selected nutritional supplement powder material, in accordance with some embodiments;

FIG. 2 is a top view of a dispensing station for dispensing a selected nutritional supplement powder material, in accordance with some embodiments;

FIG. 3 is perspective view of a dispensing station for dispensing a selected nutritional supplement powder material with the top cover removed, in accordance with some embodiments;

FIG. 4 is a cutaway side view of a detail of portion of a dispensing station for dispensing a selected nutritional supplement powder material with the top cover removed, in accordance with some embodiments;

FIG. 5 is a cutaway side view of a detail of portion of a dispensing station for dispensing a selected nutritional supplement powder material with the top cover removed, in accordance with some embodiments;

FIG. 6A is a top view of a dispensing truck for use in a dispensing station for dispensing a selected nutritional supplement powder material with the top cover removed, in accordance with some embodiments;

FIG. 6B is a top view of a dispensing truck for use in a dispensing station for dispensing a selected nutritional supplement powder material with the top cover removed, in accordance with some embodiments;

FIG. 7 is a side perspective partial cut-away view of a canister level of a dispensing station for dispensing a selected nutritional supplement powder material with the top cover removed, in accordance with some embodiments;

FIG. 8 is a bottom plan view of a dispensing level of a dispensing station for dispensing a selected nutritional supplement powder material with the top cover removed, in accordance with some embodiments;

FIG. 9 shows an electromechanical schematic for controlling operation of an actuator subject to receiving a payment, in accordance with some embodiments; and

FIG. 10 is a flowchart diagram of a method of operating a dispensing station, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel dispensing station for dispensing powdered and granular nutritional supplement and similar materials. The inventive embodiments solve the problems of inconvenience in consuming supplement and the associated waste associated with personal packaging by providing a convenient bulk dispenser. These dispensers can be loaded with bulk size amounts of various supplements, and operated to selectively dispense single serving portions. They can be located, for example, on a countertop, on a retail floor, in sports or shopping mall venues, or used behind the counter in food service establishments.

Referring now to FIG. 1, which shows a perspective view of a dispensing station 100 for dispensing a selected nutritional supplement powder material, in accordance with some embodiments. In general, the dispensing station 100 can contain an assortment of different types of nutritional supplements, such as, for example, protein powder, branched-chain amino acids, and carbohydrate-electrolyte mixtures, and can further include vitamin and mineral supplements as well. These substances are ingestible and can be mixed into beverages and other liquid-based consumable preparations (e.g. shakes, smoothie). The dispensing station 100 can be located, for example, in an exercise studio or similar athletic training facility to provide people with a choice of supplement for a particular workout or training regimen they may be performing. Further, the dispensing station 100 can be configured to require payment before dispensing any material.

Accordingly, the dispensing station 100 includes a top cover 102 that sits on a base 104. The base 104 can support the dispensing station 100 and internal components. A dispensing bay 106 can be provided in a side of the base 104 in which an open container can be placed to receive a measure of powdered or granular nutritional supplement material. A window 108 in the cover 102 can allow a person to see inside the cover so as to allow the user to select a desired one of several supplements contained inside the cover. The supplements are provided in canisters that are mounted on a rotating structure, and outside portion 110 of which can be exposed to allow a person to rotate it. The outside portion 110 can simply be the outermost edge of the rotating structure, and can be exposed through one or more lateral slots formed in the sides of the dispensing station 100 between the base 104 and cover 102. When a person has rotated the rotating structure inside the dispensing station 100 so that a desired supplement canister or container is aligned with the window 108, the user can operate an actuator 112 to move a truck or hopper component from filling position to a dispensing position. As will be explained, the rotating structure supports several canisters of powdered or granulated supplement material, rather than, for example, single serving sized packages. That is, the supplement material is contained in bulk, and is dispensed in single serving measures into the dispensing bay 106. The dispensing structure is designed to prevent contamination between the various supplements to ensure that the user is only receiving the desired supplement.

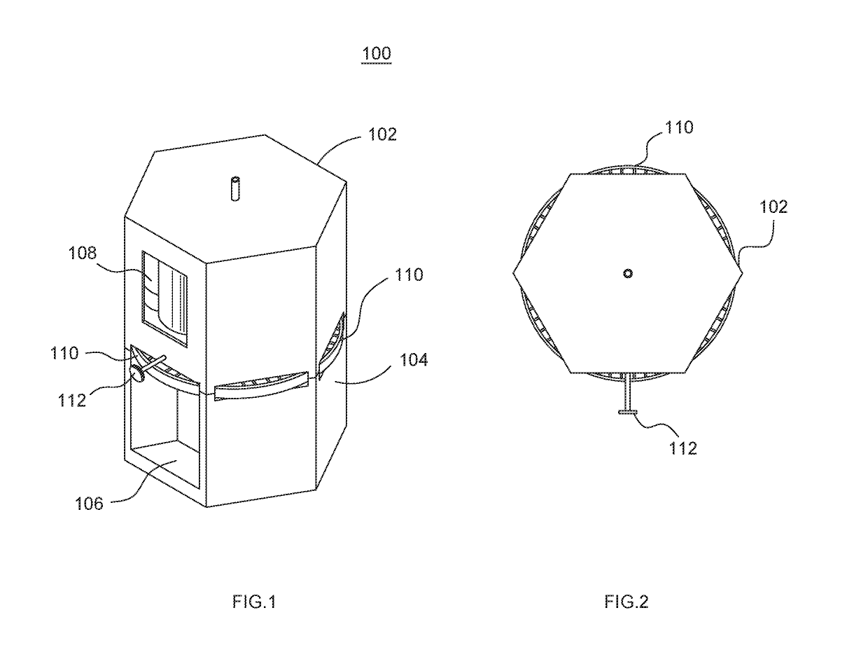

FIG. 2 is a top view of a dispensing station 100 for dispensing a selected nutritional supplement powder material, in accordance with some embodiments. In the view shown it can be seen that in some embodiments the dispensing station 100 can have a hexagonal shape. Other shapes may be used equivalently. The outside portion 110 of the rotating structure protrudes through one or more sides in some embodiments that use manual rotation of the rotating structure. However, it is contemplated that in some embodiments the rotating structure is contained entirely within the dispensing station 100, and is rotated or moved by other means, such as, for example, an electric motor that is controlled by a button that is provided at the outside of the dispensing station 100.

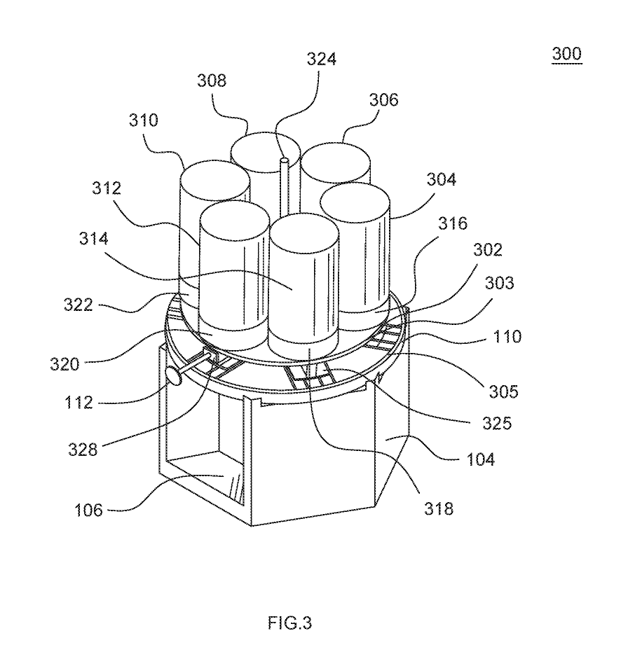

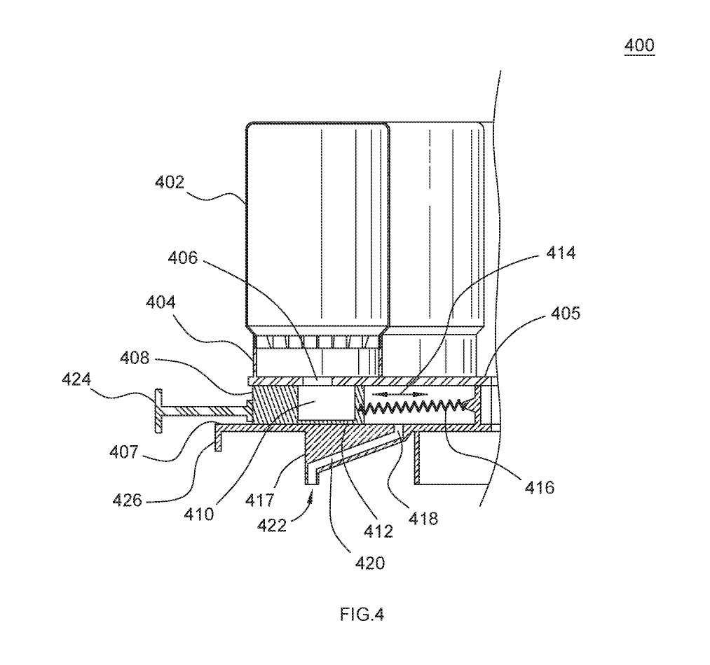

FIG. 3 is perspective view 300 of a dispensing station for dispensing a selected nutritional supplement powder material with the top cover removed, in accordance with some embodiments. The dispensing station illustrated here can be substantially similar to that of FIGS. 1 & 2. The rotating structure 302 includes two levels including a canister level 303 and a dispenser level 305 which rotate together. The rotating structure 320 rotates about an axis, such as a central vertical support column 324. The canister level 303 supports a plurality of canisters 304, 306, 308, 310, 312, 314, each of which is inverted into a canister mount such as canister mounts 316, 318, 320, 322. Each canister 304-314 contain bulk supplement material in loose, bulk powdered or granular form. Typically the canisters 304-314 have a cap or lid at one end, and a hermetic seal under the lid formed by a plastic or polymeric material that is sealed to a rim of the canister. When a canister is mounted on one of the canister mounts, the seal is broken by a structure in the canister mount to release the supplement material from the canister. Each canister mount has an opening at the bottom to allow the supplement material to flow out to the dispenser level 305 below. The canisters 304, 306, 308, 310, 312, 314 can be of different volumes, based on their height and diameter. In some embodiments a typical canister can hold several kilograms or pounds of material, and canister sizes (in volume) can be standardized by weight. For example, there can be 1 Kg, 2 Kg, 5 Kg sizes that can all fit the same canister mount. In some embodiments, much larger sizes can be used, where fifty to one hundred pound bags of supplement are used to fill canisters that can hold that much volume. In some embodiments, the canister and canister mount can be integrally formed as a refillable unit, rather than as separate components.

On the dispenser level 305, positioned under each canister mount, is a dispensing truck (or hopper) such as dispensing trucks 326, 328 under canister mounts 318, 320, respectively. Each dispensing truck is movable in a direction towards and away from the central axis of the rotating structure 302, from a filling position to a dispensing position. The trucks are normally in the filling position, biased to that position by a compression spring. The filling position is a position where a cup portion of the truck is under the canister so that the cup portion is filled by the powdered/granular material flowing out of the canister. The cup portion has a selected volume equal to a desired measure, such as, for example, 5, 10, 15, 20 grams, or more. Accordingly, there can be two or more canisters of the same supplement in the canister mounts, but with different sized sup portions for their respective trucks. The trucks each have an opening in the bottom of the cup portion, and when the truck is moved to the dispensing position, the opening in the bottom of the cup portion is then aligned with the top opening of a dispensing chute formed in the bottom of the dispensing level of the rotating structure under each truck location. The powdered/granular material then flows out of the cup portion and down the dispensing chute. The dispensing chute is configured to deliver the powered/granular material into the dispensing bay (e.g. 106) where it can fall into a container provided by a user. Therefore, for each canister of supplement material, there is a canister mount, a dispensing truck, and a dispensing chute. This configuration minimizes cross contamination as each canister mount, dispensing truck, and dispensing chute are dedicated to one canister.

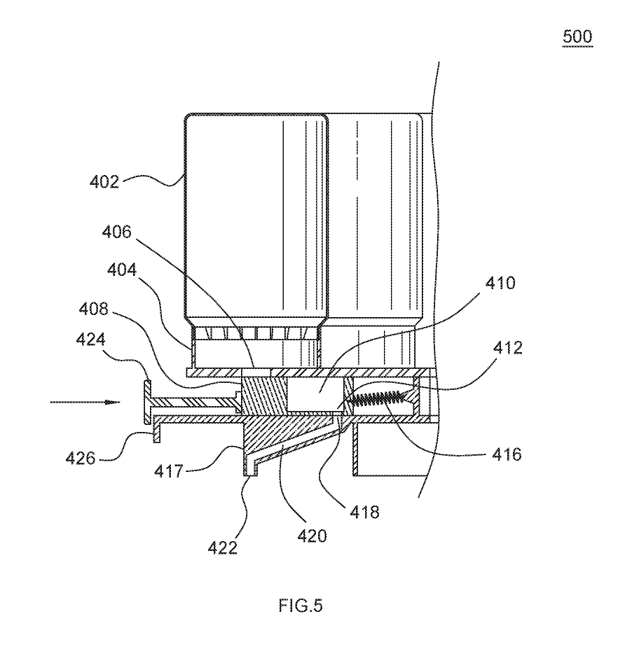

FIGS. 4 and 5 illustrate the movement of a dispensing truck between the filling and dispensing positions. Each figure shows the same canister location including a canister installed on a canister mount on a canister level of the rotating structure, with a dispensing truck below on the dispensing level, and a dispensing chute formed into the underside of the dispensing level. Thus, the configuration shown in FIGS. 4-5 is duplicated at each canister location on the rotating structure.

FIG. 4 is a cutaway side view of a detail of portion of a dispensing station 400 for dispensing a selected nutritional supplement powder material with the top cover removed, in accordance with some embodiments. A canister 402 contains a powdered/granular nutritional supplement material (e.g. protein powder, branched-chain amino acid, carbohydrate-electrolyte mix, and so on), and in mounted on a canister mount 404. The canister mount 404 on the canister level 405 is sized to receive the mouth of the canister 402. Generally, the canister 402 includes a lid (not shown) under which is a seal over the mouth of the canister which allows the canister to be inverted without spilling the contents. A piercing or cutting structure is mounted in the canister mount 404 to open that seal once the canister 402 is engaged in the canister mount 404, but for clarity here, that structure is not shown. Once the canister 402 is mounted on the canister mount 404, the powdered/granular material inside flows into the space under the canister 402, and through a port 406 through the bottom of the canister mount 404.

Underneath the canister mount 404, on the dispenser level 407, is a dispensing truck 408. The dispensing truck 408 is moveable across the dispenser level 407 laterally, as indicated by arrow 414. The dispensing truck 408 is shown in a filing position where a cup portion 410 is located under the port 406 to allow the powdered/granulated material to flow into the cup portion 410. The cup portion 410 has a preselected volume corresponding to a desired measure (e.g. one tablespoon, one ounce, etc.) suitable for a single serving of the particular supplement material in the canister 402. A dispensing hole 412 is formed in the bottom of the cup portion 410, but in the filling position as shown, the dispensing hole is closed off by the surface of the dispending level 407. The dispensing truck is biased into the filling position by a compression spring 416. The dispensing level 407 has a dispensing structure 417 formed on a bottom of the dispensing level 407, in which a dispensing chute 420 (or channel) is formed between a receiving port 418 and a dispensing end 422 of the dispensing chute 420. When the rotating structure is positioned such that the canister 402 is aligned for dispensation (e.g. aligned with window 108), then the actuator 424 will be aligned with the dispensing truck 408. The actuator 424 is operable by a user to push the dispensing truck 408 from the filling position as shown here, to the dispensing position as shown in FIG. 5.

FIG. 5 is a cutaway side view of a detail of portion of a dispensing station 100 for dispensing a selected nutritional supplement powder material with the top cover removed, in accordance with some embodiments. In this view the actuator 424 has been pushed in by a user, causing the dispensing truck 408 to move toward the center of the rotating structure. The motion causes the compression spring 416 to become compressed, creating or increasing the force opposing the movement of the dispensing truck that is overcome by the force applied to the actuator by the user. As the dispensing truck is moved from the filling position, a top surface of the dispensing truck closes off the port 406 at the bottom of the canister mount 404, preventing material from spilling out of the canister mount 404. When the dispensing truck 408 is moved to the dispensing position as shown, the dispensing hole 412 in the bottom of the cup portion 410 is aligned with the receiving port 418 of the dispensing chute 420, allowing the supplement material in the cup portion 410 to flow down the dispensing chute 420 to the dispensing end 422 where it will fall out into a container placed there by the user. The dispensing chute can be a channel that is formed at an angle as shown, to cause the supplement material to flow down the chute, towards the front of the dispensing station. However, it is also contemplated that, in some embodiments, the chute can be configured as a vertical channel between the receiving port 418 and dispensing end 422. A stopping feature can be provided that prevent the dispensing truck from being moved past the dispensing position. When the actuator 424 is released, the dispensing truck 408 is moved back to the filling position (as in FIG. 4) by the compression spring 416 expanding. As the dispensing truck 408 is moved back to the filling position, the cup portion 410 moves under the port 406 and is refilled with supplement material, assuming there is more supplement material in the canister 402 and canister mount 404.

It will be appreciated by those skilled in the art that the actuator 424 as shown here, is supported by structure that is not shown for the sake of clarity in the drawings. The actuator 424 may also include a spring means to keep it biased outwards. This will keep the actuator out of the way when the rotating structure is rotated.

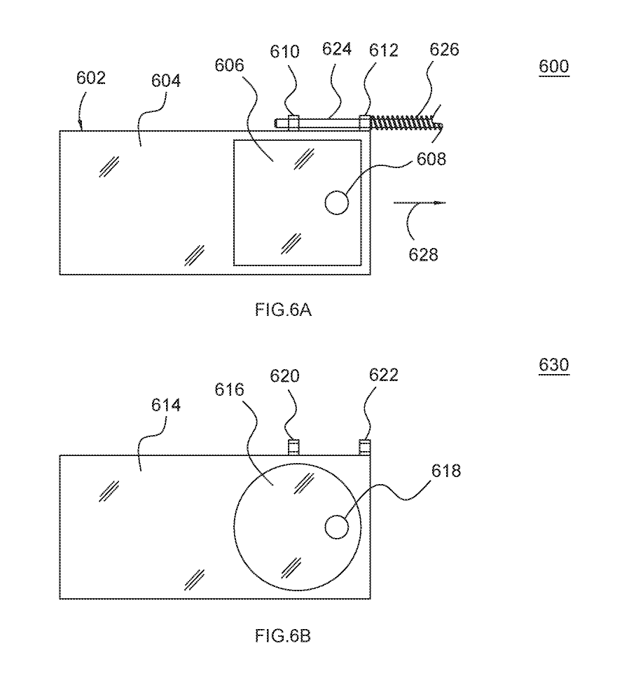

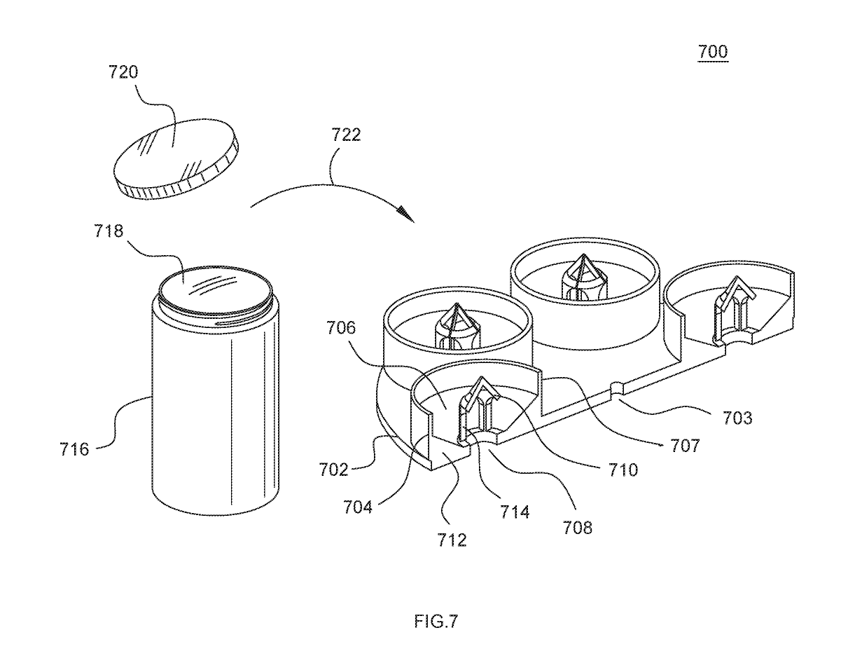

FIG. 6A is a top view of a dispensing truck 600 for use in a dispensing station for dispensing a selected nutritional supplement powder material with the top cover removed, in accordance with some embodiments. The dispensing truck 600 can be used in the dispensing stations shown in any of the previous drawings. The body 602 of the dispensing truck 600 includes a flat top surface 604, and a cup portion 606. The cup portion 606 is recessed into the page relative to the top surface 602, as shown here, and includes a dispensing hole 608 at the bottom of the cup portion 606. The bottom surface can be sloped towards the dispensing hole 608 to encourage material in the cup portion 606 to pass through the dispensing hole 608.

To bias the dispensing truck 600 to the filling position under the canister, a compression spring 626 can be used, as shown FIGS. 4-5. To connect the compression spring 626 to the dispensing truck 600, a pair of guide rod bosses 610, 612 on a side of the dispensing truck 600 can capture a guide rod 624 on which the compression spring 626 is captured. As the dispensing truck 600 is moved in the direction of arrow 628 the compression spring 626 is compressed (more). The guide rod 624 remains stationary, and the guide rod bosses 610, 612 move along the guide rod 624. Then the force acting on the dispensing truck 600 to move it in the direction of arrow 628 is removed, the compression spring 626 expands, pushing the dispensing truck 600 back to the filling position.

FIG. 6B is a top view of a dispensing truck 630 for use in a dispensing station for dispensing a selected nutritional supplement powder material with the top cover removed, in accordance with some embodiments. Dispensing truck 630 also includes a flat top surface 614, and a cup portion 616. The cup portion 616 is round, rather than being square/rectangular as in dispensing truck 600. A dispensing hole 618 is disposed in the bottom of the cup portion 616. In some embodiments, the dispensing truck 630 can further include guide rod bosses 620, 622 to capture a guide rod and compression spring, such as 624, 626 in FIG. 6A.

FIGS. 6A and 6B represent some embodiments of a dispensing truck, but those skilled in the art will appreciate that similar configurations can be realized equivalently. In general, and dispensing truck includes a cup portion for holding a measure of powdered/granular material with a dispending hole at the bottom of the cup portion. The dispensing opening is closed off until and unless the dispensing truck is moved to the dispensing position. There is also a means for closing off the flow of material from the canister above, such as the top surface of the dispensing truck that is laterally adjacent to the opening of the cup portion. In some embodiments the dispensing trucks can be moved along tracks or rails on the surface of the dispensing level of the rotating structure, or alternatively, in some embodiments, on guide rods. The means for biasing the dispensing truck into the filling position can be accomplished by a compression spring in some embodiments, and in some embodiments an elastic member or spring can be coupled to the dispensing truck that pulls the dispensing truck back into the filling position.

FIG. 7 is a side perspective partial cut-away view of a canister level 700 of a dispensing station for dispensing a selected nutritional supplement powder material, in accordance with some embodiments. The canister level 700 can represent the canister level of a rotating structure as shown, for example, in FIGS. 1-5. The canister level 700 comprises a generally planar body 702 on which are formed a plurality of canister mounts such as canister mount 704, and which rotated about a central point 703. Each canister mount includes a receiving volume 706 defined by a wall 707 of the canister mount. The bottom 712 of the canister mount 704, which defines the bottom of the receiving volume 706 can be sloped to a centrally located port 708. The port 708 allows material to flow through the canister level into the dispensing level below. Over the port 708 is a seal breaking structure that can include a blade structure 710 formed by several angled members meeting a pointed or sharp apex over the port 708. The angled members can be edged, and can be made of metal or plastic. The apex must be at a level above the top of the wall 707 to ensure it pierces the sealing film of a canister. A standoff structure 714 supports the blade structure at a sufficient height over the port so that the point or peak of the apex of the blade structure is above the wall 707.

A canister 716 contains a bulk volume of material to be dispensed, and has a canister mouth that is sealed by a sealing member 718. The sealing member 718 can be a thin plastic film that is adhered to a rim of the mouth of the canister 718, as is common. To install the canister 718 into the dispensing station, the canister lid 720 is removed from the canister 716 to expose the sealing member 718, and then the canister 716 is inverted, as indicated by arrow 722, to place the mouth of the canister 716 into the canister mount 704. As the inverted canister 716 is lowered into engagement with the canister mount 704, the apex of the blade structure 710 pierces or cuts though the sealing member 718, thereby allowing the material therein to flow out of the canister 716. The canister 716 can fit into the canister mount 704 and be held in place by friction retention or other mechanical interference, include threads.

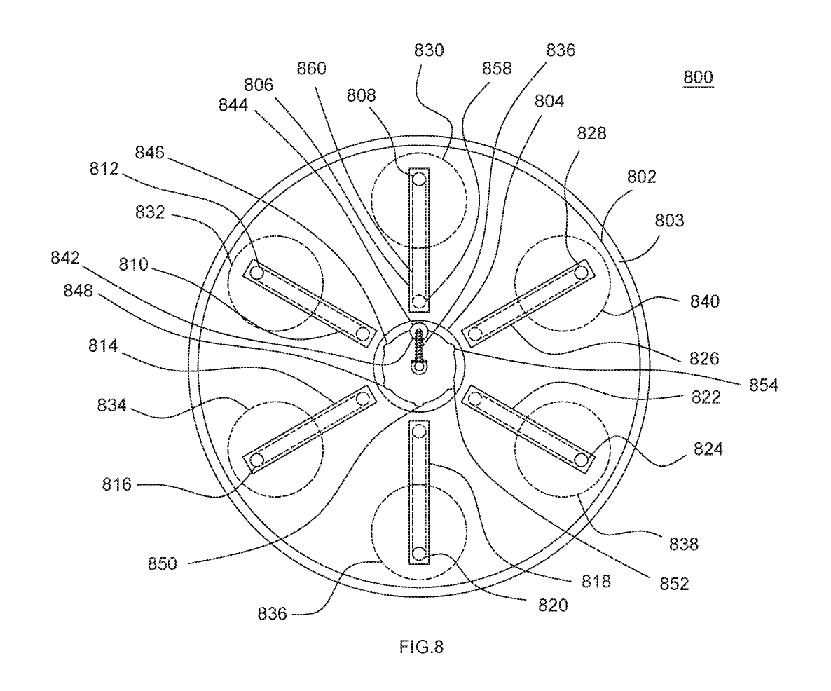

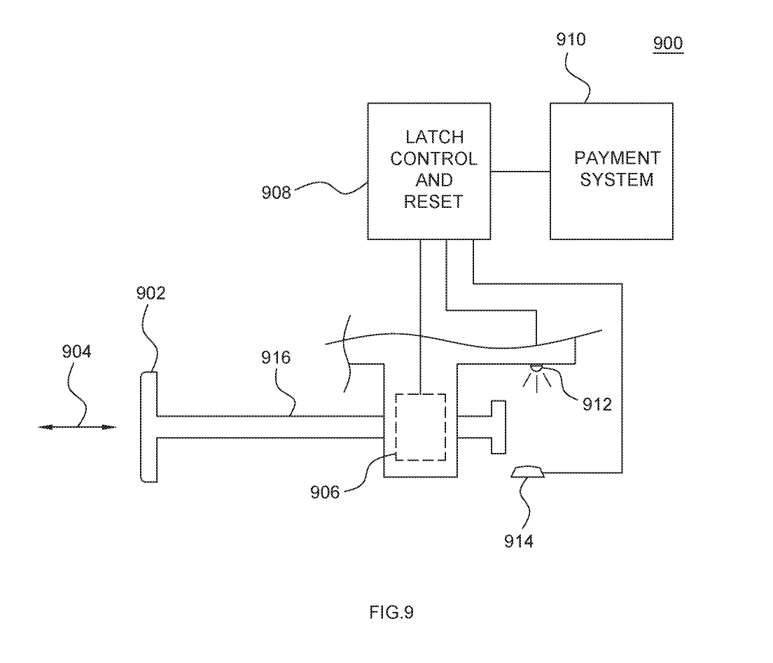

FIG. 8 is a bottom plan view of a dispensing level 800 of a dispensing station for dispensing a selected nutritional supplement powder material with the top cover removed, in accordance with some embodiments. The dispensing level comprises a planar body 802 that can have a rim 803 around the outside. The top surface (facing away from, and into the page) can be generally flat, with feature for guiding dispensing trucks, and mounting springs and other components related to positioning the dispensing trucks. On the bottom, as shown, a central hub 804 can define a space between the central hub and the rim 803 in which a plurality of dispensing structures 806, 810, 814, 818, 822, 826 are formed, which can be substantially similar to structure 417 of FIG. 4. Each of these structures have a dispensing end 808, 812, 816, 820, 824, 828, respectively, of a dispensing chute passing through the structure. Each structure is further partially located under a corresponding canister mount 830, 832, 834, 836, 838, 840, and is oriented radially with respect to the center of the body 802. By arranging the canister mounts 830, 832, 834, 836, 838, 840 at or near the rim 803 (i.e. away from the center), the number of canister mounts can be maximized for the given diameter of the body 802. Thus, the dispensing trucks (not shown here) and the dispensing structures 806, 810, 814, 818, 822, 826 are configured such that the dispensing trucks are pushed inward, toward the center of the rotating structure, to dispense the material through the dispensing chute. Each dispensing structure 806, 810, 814, 818, 822, 826 includes a dispensing chute such as chute 860, and has a receiving port such as receiving port 858. As shown in FIGS. 4-5, the receiving port 858 receives material from a corresponding dispensing truck. The material then flows down the dispensing chute 806 and exits at the dispensing opening 808.

Of course, the only way to dispense material is to move the rotating structure so that the canister containing the desired material is aligned with the actuator at the front of the dispensing station. In order to ensure that the desired canister location is aligned with the front of the dispensing station, a detent mechanism can be used to give tactile feedback to the user as the user turns the rotating structure, and the detent mechanism can then resist further movement of the rotating structure to hold it in position. For example, around the inside of the central hub 804 there can be a plurality of semi-circular reliefs 844, 846, 848, 850, 852, 854 along an inner rim of the hub. A spring-biased roller 842 is biased outward from the center of the rotating structure by a spring assembly 856. When the body 802 is rotated, the roller 842 turns as the inner rim of the hub 804 turns, and when one of the semi-circular reliefs 844, 846, 848, 850, 852, 854 moves to the position of the roller 842, the spring assembly 856 urges the roller 842 into the relief. In order to rotate the body 802 further, the spring force of the spring assembly 854 must be overcome to push the roller 442 back towards the center of the body 802, as the inner rim of the hub continues to move past the roller 842 and the roller continues to turn in correspondence. The user turning the body 802 (i.e. the rotating structure) will feel the resistance of the roller when the roller is in one of the reliefs 844, 846, 848, 850, 852, 854. The resistance will also tend to hold the body 802 in position so long as a force necessary to displace the roller 842 is not applied to the body 802.

FIG. 9 shows an electromechanical schematic 900 for controlling operation of an actuator 902 subject to receiving a payment, in accordance with some embodiments. The actuator 902 can be substantially similar to that of previous drawings, and is operated by a user to push a dispensing truck from a loading position to a dispensing position to dispense a portion of material as previously described herein. The actuator 902 moves horizontally in the direction of arrow 904, and is normally locked in place and prevented from moving by an electrically operated latch 906. The latch 906 is controlled by a latch control circuit 908. For example, the latch 906 can be operated by a solenoid or similar electromechanical component. A current or other electrical signal from the latch control circuit 908 can temporarily disable the latch 906, allowing movement of the actuator 902 to move a dispensing truck. The latch control circuit can be responsive to a payment system 910 that receives and processes payments, as is well known. Upon successfully receiving a payment, the payment system 910 can provide a control signal to the latch control circuit 908, causing the latch control circuit to temporarily disable or disengage the latch 906, allowing the user to move the actuator 902.

To reset the latch, a sensor can be used, such as, for example, an optical sensor 914 that senses light from a light source 912. As the actuator 902 is moved past the light source 912, it blocks light from reaching the light sensor 914, resulting in a change in an output signal of the light sensor that is observed or processed by the latch control circuit 908. When the actuator 902 returns to its resting position (such as by urging of a spring acting on the actuator 902), light from the light source 912 will again be evident and detected at the light sensor 914, providing a signal to the latch control circuit 908 indicating such, whereupon the latch control circuit 908 again enables the latch 906 until another payment is processed.

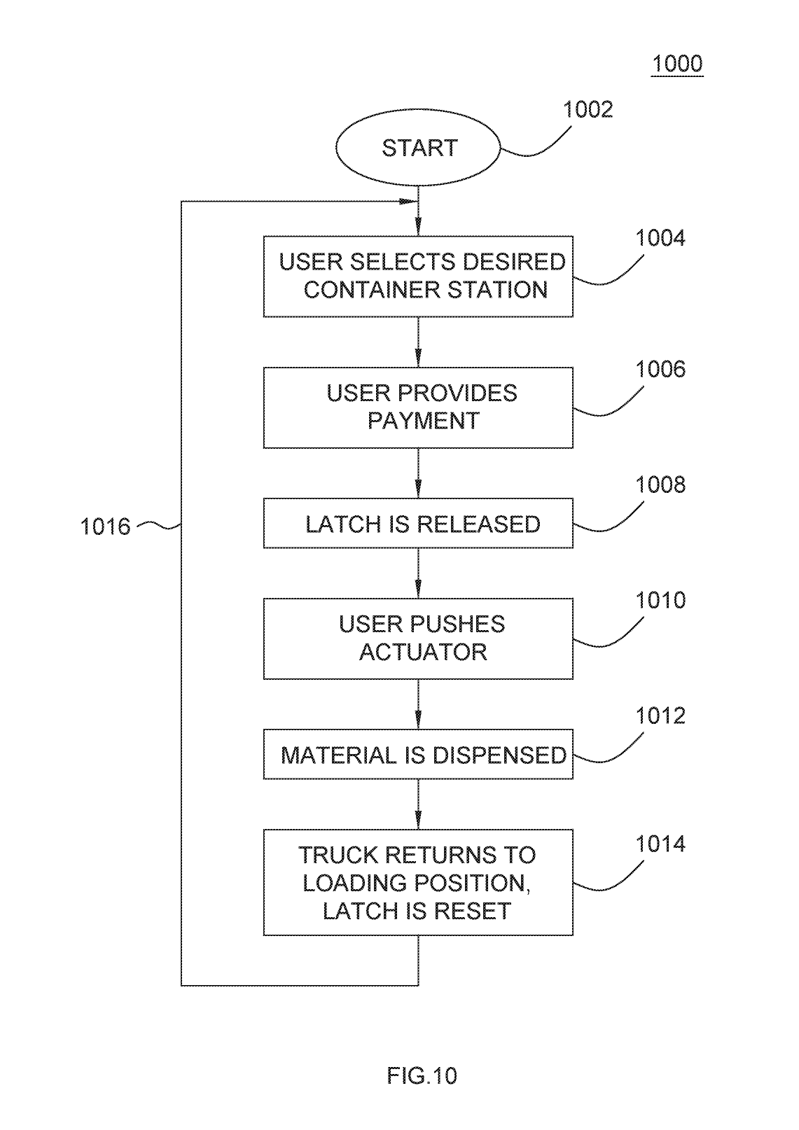

FIG. 10 is a flowchart diagram of a method 1000 of operating a dispensing station, in accordance with some embodiments. The dispensing station can be substantially similar to that illustrated in the foregoing drawings, and at the start 1002, the dispensing station can be provided and including a plurality of container stations. Each container station can include a container or a canister mount that is configured to receive a standardized canister of powered material. A container in a container station is essentially closeable structure that can hold a volume of material that is not intended to be removed. At step 1004 a user can select a desired one of the container stations, which contains a powered supplement that the user wishes to consume. In step 1006, in systems that require payment, the user can provide the requisite payment. In step 1008, responsive to receiving the payment, the actuator is released and can be moved. In step 1010 the user pushes the actuator to move the corresponding dispensing truck from the filling position to the dispensing position to dispense the powered material contained in the cup portion of the dispensing truck. In step 1012 the powdered material is dispensed, such as through a dispensing chute, and into a container provided by the user. In step 1014 the user releases the actuator and it returns to its rest position, and the dispensing truck returns to its filling position. The method can then be repeated, as indicated by line 1016.

Accordingly, embodiments of the disclosure provide a dispensing station for powered materials that is suited particularly for dispensing measured portions of powdered nutritional supplement material. The dispensing station can be placed in locations where people commonly engage in exercise or athletic activities, as well as in retail and food service establishments. As such, the inventive dispensing station can provide the benefit of obviating the need for a person to bring along their own containers of powdered supplement when they go to work out or attend athletic practice, for example. This can be a considerable convenience particularly for people who consume more than one type of supplement.

What is claimed is:

1. A dispensing station for dispensing powder and granulated material into beverage containers, comprising:
a rotating structure having a canister level and a dispenser level which rotate together about a central axis;
the canister level including a plurality of canister mounts that are each configured to receive a canister and direct material contained in the canister through a port in a bottom of the canister mount;
the dispenser level include a plurality of dispensing trucks, each one of the plurality of dispensing trucks positioned underneath a respective one of the plurality of canister mounts on the dispenser level, and moveable between a filling position and a dispensing position, wherein, for each dispensing truck, in the filling position a cup portion of the dispensing truck is aligned with the respective port under the respective canister mount, and in the dispensing position a dispensing hole in a bottom of the cup portion is aligned with a receiving port of a dispensing chute, and wherein the dispensing chute is configured to direct a powdered or granular material from the cup portion to a container positioned under a dispensing end of the dispensing chute; and
an actuator mounted in a fixed position with respect to the rotating structure that is configured to move a selected one of the dispensing trucks between the filling and dispensing positions, and wherein the selected one of the dispensing trucks is selected by rotating the rotating structure until the selected one of the dispensing trucks is in alignment with the actuator.

2. The dispensing station of claim 1, further comprising, for each one of the plurality of dispensing trucks, a respective one of a corresponding plurality of biasing springs that biases the one of the plurality of dispensing trucks to the filling position.

3. The dispensing station of claim 1, wherein each canister mount includes a protrusion positioned over the port that is configured to cut through a seal of a canister upon a canister being mounted on the canister mount.

4. The dispensing station of claim 1, wherein the bottom of each canister mount is sloped from a sidewall of the canister mount to the port.

5. The dispensing station of claim 1, wherein the actuator comprises a pushrod assembly that moves along a radius with respect to a center of the rotating structure.

6. The dispensing station of claim 1, wherein the actuator is inhibited from moving by a latch and latch control circuit that is responsive to a payment system, wherein upon the payment system receiving a payment, the latch control circuit releases the latch for one cycle of the actuator, thereby allowing dispensation of one portion.

7. The dispensing station of claim 1, wherein at least two of the trucks have different sized cup portions.

8. A dispensing station for dispensing powder and granulated material into beverage containers, comprising:
a plurality of container stations, each one of the container stations having either a container or a canister mount configured to receive a canister, and a dispensing truck of a plurality of dispensing trucks is disposed below the container station that is movable between a filling position and a dispensing position;
wherein, in the filling position, each dispensing truck is positioned such at a cup portion of the dispensing truck is filled with material contained in the container or canister of the container station through a port, and when moved to the dispensing position a portion of the dispensing truck closes off the port;
wherein, in the dispensing position, material in the cup portion exits the cup portion through dispensing hole in the cup portion into a dispensing chute, and when moved to the filling position the dispensing hole is closed off;
wherein the dispensing chute guides the material to a dispensing end of the dispensing chute; and
wherein the dispensing trucks are moved by an actuator that is mounted in a fixed position, and wherein the plurality of container stations can be moved by a user to select a desired one of the container stations by aligning the selected one of the container stations with the actuator.

9. The dispensing station of claim 8, wherein the container stations are disposed in a rotating structure which includes a canister level on which the container or canisters are located, and a dispenser level on which the plurality of dispensing trucks are disposed.

10. The dispensing station of claim 9, further comprising, for each one of the plurality of dispensing trucks, a respective one of a corresponding plurality of biasing springs that biases the one of the plurality of dispensing trucks to the filling position.

11. The dispensing station of claim 8, wherein, for each container station which includes a canister mount, each canister mount includes a protrusion positioned over the port that is configured to cut through a seal of a canister upon a canister being mounted on the canister mount.

12. The dispensing station of claim 11, wherein the bottom of each canister mount is sloped from a sidewall of the canister mount to the port.

13. The dispensing station of claim 9, wherein the actuator comprises a pushrod assembly that moves along a radius with respect to a center of the rotating structure.

14. The dispensing station of claim 8, wherein the actuator is inhibited from moving by an actuator control that is responsive to a payment system, wherein upon the payment system receiving a payment, the payment system releases the actuator control for one cycle of the actuator, thereby allowing dispensation of one portion.

15. The dispensing station of claim 8, wherein at least two of the trucks have different sized cup portions.

16. A method for dispensing powdered material, comprising:
providing a dispensing station having a plurality of container stations, each container station including a container of powdered material, and a dispensing truck located under the container that is moveable between a filling position and a dispensing position;
moving the plurality of container stations relative to an actuator until a selected one of the container stations aligns with the actuator, wherein the actuator is particularly aligned with the dispensing truck of the selected container station; and
moving the actuator, and thereby moving the dispensing truck of the selected container station from a filling position to a dispensing position, wherein a selected measure of the powered material is dispensed from the dispensing truck of the selected container station into a dispensing chute having a receiving port that corresponds with a dispensing hole in the dispensing truck when the dispensing truck is in the dispensing position.

17. The method of claim 16, wherein moving the plurality of container stations comprises moving the plurality of container stations on a rotating structure.

18. The method of claim 16, wherein at least two of the dispensing trucks have a different capacity, moving the plurality of container stations is based on the capacity of the dispensing trucks.

19. The method of claim 16, further comprising:
providing a payment to a payment system associated with the dispensing station; and
responsive to receiving the payment, disabling a latch the is configured to prevent the actuator from moving a dispensing truck, thereby allowing the actuator to move.

20. The method of claim 16, wherein each container station includes a canister mount, the method further comprises loading a canister of powered material into each of the canister mounts.
